(19) United States
(12) Patent Application Publication
(10) Pub. No.: US 2026/0003031 A1
(43) Pub. Date: Jan. 1, 2026

(54) RADAR MODULE AND RADAR DEVICE COMPRISING SAME

(71) Applicant: LG INNOTEK CO., LTD., Seoul (KR)

(72) Inventor: Woo Cheon PARK, Seoul (KR)

(73) Assignee: LG INNOTEK CO., LTD., Seoul (KR)

(21) Appl. No.: 18/852,985

(22) PCT Filed: Mar. 31, 2023
(86) PCT No.: PCT/KR2023/004349

§ 371 Date: Jun. 6, 2025

(30) Foreign Application Priority Data
Mar. 31, 2022 (KR) 10-2022-0040807

(51) Int. Cl. G01S 7/03; B60R 21/015; H01Q 1/32; H01Q 13/10

(52) U.S. Cl. CPC G01S 7/032; B60R 21/01534; B60R 21/01542; H01Q 1/3208; H01Q 1/3291; H01Q 13/10

(57) ABSTRACT

A radar module according to an embodiment includes a substrate; a communication device disposed on the substrate; an antenna unit disposed on the substrate; and a connection line disposed on the substrate and connecting the communication device and the antenna unit, and including at least one stub, wherein the antenna unit includes: a radiator including a feeding slot; and a feeding line connecting the connection line and the radiator, and a direction of a beam radiated from the antenna unit is adjusted by controlling a first variable related to the feeding slot and a second variable related to the stub.

### TECHNICAL FIELD

An embodiment relates to a radar module, and more particularly, to a radar module capable of maintaining or increasing antenna performance without changing a communication device and a main component configuration, and to a radar device and a vehicle sensing system including the same.

### BACKGROUND ART

A radar device is applied to various fields of technology, and recently, the radar device is installed in a vehicle to improve a mobility of the vehicle. The radar device senses information about a surrounding environment of the vehicle using electromagnetic waves. To this end, the radar device is equipped with an antenna to transmit and receive electromagnetic waves.

A vehicle radar can be classified into a long-range radar device (LRR) and a short-range radar device (SRR). The long-range radar device mainly uses a 77 GHz band frequency, and the short-range radar device mainly uses a 24 GHz band frequency. In order for vehicle radars including both the long-range radar device and the short-range radar device to simultaneously sense objects located at long and short ranges, an optimal antenna channel spacing and antenna gain must be secured to secure a FOV (Field Of View) and a sensing distance.

Meanwhile, in modern society, vehicles are most common means of transportation, and a number of people using vehicles is increasing. As a result, there is a problem such as neglecting an infant in a vehicle due to carelessness.

Accordingly, when a driver gets out of the vehicle, a rear occupant alert device (ROA) is recently provided to sense whether a rear occupant (especially, infant) remains in a vehicle interior using the radar device, and to provide alert on this.

The rear occupant alert device generates a driver's cluster warning and warning sound when a rear occupant is sensed when the driver gets out of the vehicle. If the driver does not recognize the infant in a rear seat and completely gets out and locks a door, the rear occupant alert device senses movement inside the vehicle by operating the radar device installed at a vehicle ceiling. Thereafter, when movement of the rear occupant is sensed, the rear occupant alert device performs at least one of following actions: generating a horn sound, flashing an emergency light, and sending a text message. Accordingly, it is possible to prevent accidents of neglecting the infant.

(Patent Document 1) KR 10-151378 B

### DISCLOSURE

### Technical Problem

An embodiment provides a radar module, a radar device, and a vehicle sensing system including the same, which can optimize antenna performance according to an installation location of the radar module.

In addition, the embodiment provides a radar module, a radar device, and a vehicle sensing system including the same, which can form an antenna beam in an accurate direction regardless of an installation location.

In addition, the embodiment provides a radar module, a radar device, and a vehicle detection system including the same, which can adjust a direction of an antenna beam while maintaining a physical position according to an installation location of an antenna.

In addition, embodiment provides a radar module, a radar device, and a vehicle sensing system including the same, which can maintain or increase antenna performance without changing a main component configuration of the radar module.

In addition, the embodiment provides a radar module, a radar device, and a vehicle sensing system including the same, which can adjust a direction of an antenna beam by changing an inset length and width of a feeding slot of a radar module.

In addition, the embodiment provides a radar module, a radar device, and a vehicle sensing system including the same, which can adjust a direction of an antenna beam by changing a length of a stub of the radar module, a width of the stub, a number of stubs, and a spacing between a plurality of stubs.

In addition, the embodiment provides a radar module, a radar device, and a vehicle sensing system including the same, which can optimize the performance of the radar module according to an installation region of the radar module in the vehicle.

In addition, the embodiment provides a radar module, a radar device, and a vehicle sensing system including the same, which can be applied to various structures.

In addition, the embodiment provides a radar module, a radar device, and a vehicle sensing system including the same, which can minimize signal transmission loss.

In addition, the embodiment provides a radar module, a radar device, and a vehicle sensing system including the same, which can improve a degree of design freedom.

Technical problems to be solved by the embodiments proposed herein are not limited to those mentioned above, and other unmentioned technical aspects should be clearly understood by one of ordinary skill in the art to which the embodiments proposed herein pertain from the description below.

### Technical Solution

A radar module according to an embodiment comprises a substrate; a communication device disposed on the substrate; an antenna unit disposed on the substrate; and a connection line disposed on the substrate and connecting the communication device and the antenna unit, and including at least one stub, wherein the antenna unit includes: a radiator including a feeding slot; and a feeding line connecting the connection line and the radiator, and a direction of a beam radiated from the antenna unit is adjusted by controlling a first variable related to the feeding slot and a second variable related to the stub.

In addition, the first variable includes a length of the feeding line and a width of the feeding line.

In addition, the second variable includes a length of the stub.

In addition, the stub includes: a first stub disposed on one side of the connection line; and a second stub disposed on other side of the connection line opposite to the one side, and wherein the second variable includes a length of the first stub, a length of the second stub, and a spacing between the first stub and the second stub.

In addition, the radiator includes a plurality of radiators, and the feeding slot is formed in a radiator farthest from the connection line among the plurality of radiators.

In addition, the antenna unit includes: a transmitting antenna unit; and a receiving antenna unit, wherein the connection line includes: a transmission line connected to the transmitting antenna unit; and a reception line connected to the receiving antenna unit, a value of the first variable of a feeding slot of the transmitting antenna unit is same as a value of the first variable of a feeding slot of the receiving antenna unit, and values of the second variables of the first and second stubs formed on the transmission line are same as values of the second variables of the first and second stubs formed on the reception line.

In addition, a length of the feeding slot is adjusted within a range of 15% to 50% of a length of the farthest radiator.

In addition, the communication device includes: a plurality of transmitting terminals connected to the transmitting antenna unit; and a plurality of receiving terminals connected to the receiving antenna, the plurality of transmitting terminals are arranged spaced apart in a first direction on the substrate, the plurality of receiving terminals are arranged spaced apart in a second direction perpendicular to the first direction on the substrate, and each of the transmitting antenna unit and the receiving antenna unit is arranged to extend in a third direction between the first direction and the second direction on the substrate.

In addition, the third direction is a direction rotated by an angle of 30 to 45 degrees from the first direction to the second direction.

Meanwhile, a radar device according to an embodiment comprises a radar module adapted to sense movement of an object in a vehicle; and a control unit adapted to detect the movement of the object in the vehicle using a reception signal acquired through the radar module, and output a movement sensing signal of the object when the movement of the object is sensed, wherein the control unit is adapted to output the movement sensing signal to at least one of a pre-registered terminal and an electronic control unit of the vehicle based on whether the sensed object is moving, wherein the radar module includes: a communication device disposed on the substrate; an antenna unit disposed on the substrate; and a connection line disposed on the substrate and connecting between the communication device and the antenna unit, and including at least one stub, wherein the antenna unit includes: a radiator including a feeding slot; and a feeding line connecting between the connection line and the radiator, wherein the stub includes a first stub arranged on one side of the connection line; and a second stub arranged on other side of the connection line opposite to the one side, and wherein a first variable including a length of the feeding line and a width of the feeding line and a second variable including a length of the first stub, a length of the second stub, and a spacing between the first stub and the second stub are adjusted in order to adjust a direction of a beam radiated from the antenna unit.

### Advantageous Effects

The embodiment includes a radar module. The radar module includes a communication device and an antenna unit. At this time, since the antenna unit of the radar module is installed in a fixed location, there may be a problem that the antenna performance deteriorates depending on an installation location. For example, a direction of a beam radiated from the antenna unit may be a direction other than a target direction. Accordingly, the embodiment allows a direction of a beam of the antenna unit to correspond to the target direction by adjusting a first variable related to a feeding slot and a second variable related to a stub even when the antenna unit is installed in a fixed location. At this time, the first variable may include a length and a width of the feeding slot. In addition, the second variable related to the stub includes a length of the stub. At this time, when the stub is composed of a plurality of pieces, the second variable includes lengths of each of the first and second stubs. The second variable includes a spacing between the first stub and the second stub.

Accordingly, the embodiment can allow the direction of the beam radiated from the antenna unit to correspond to the target direction by adjusting the first and second variables as described above, thereby improving the antenna performance accordingly. Furthermore, the embodiment can improve the sensing accuracy of the object as the direction of the beam corresponds to the target direction, thereby improving user satisfaction accordingly.

Meanwhile, the antenna unit includes a transmitting antenna unit and a receiving antenna unit. In addition, the embodiment allows characteristics of the transmitting antenna unit to correspond to characteristics of the receiving antenna unit. For example, values for the first and second variables of the transmitting antenna unit can be substantially the same as values for the first and second variables of the receiving antenna unit. Accordingly, the embodiment can maintain both the transmitting characteristics and the receiving characteristics of the antenna unit, thereby improving the overall performance of the radar module.

Meanwhile, the communication device in the embodiment includes a plurality of transmitting terminals spaced apart in a first direction and a plurality of receiving terminals spaced apart in a second direction perpendicular to the first direction. At this time, each of the transmitting antenna unit and the receiving antenna unit in the embodiment is disposed in a third direction different from the first direction and the second direction.

For example, a conventional technology includes the transmitting antenna unit and the receiving antenna unit disposed in a same direction as the first direction or the second direction. Accordingly, conventional technology has a problem of deteriorating overall antenna performance. For example, the conventional technology had a problem in that a difference in length between a transmission line connected to the transmitting antenna and a reception line connected to the receiving antenna increased, and thus the signal transmission loss increased. In addition, the conventional technology has a problem that the space utilization for arranging the transmitting and receiving antenna units on the substrate is reduced due to an arrangement structure of the antenna unit as described above. Furthermore, the conventional technology has a problem in that the degree of design freedom for antenna arrangement is low, and thus the ease of design is deteriorated.

In contrast, the embodiment arranges the transmitting antenna unit and the receiving antenna unit in a third direction between the first direction and the second direction as described above. Through this, the embodiment can minimize a difference in length between the transmission line and the reception line, and can minimize the signal transmission loss. Furthermore, the embodiment can improve the overall antenna performance by minimizing the signal transmission loss. In addition, the embodiment can improve space utilization for the arrangement of the transmitting antenna unit and the receiving antenna unit on the substrate. Furthermore, the embodiment can improve the design freedom for the antenna arrangement, and can easily design the antenna.

### DESCRIPTION OF DRAWINGS

FIG. 1 is a plan view showing a radar module according to a comparative example.

FIG. 2 is a schematic configuration diagram of a vehicle sensing system according to an embodiment.

FIG. 3 is a diagram showing a rear occupant alert device of FIG. 2.

FIG. 4 is a detailed configuration diagram of the radar module of FIG. 3.

FIG. 5 is a diagram explaining lengths of transmission lines and reception lines of a radar module according to a comparative example.

FIG. 6 is a diagram explaining lengths of transmission lines and reception lines of a radar module according to an embodiment.

FIG. 7 is a diagram showing signal transmission loss according to line length.

FIG. 8 is a view for comparing beam directions of radar devices according to a comparative example and an embodiment.

FIG. 9 is a view showing an antenna structure of a radar module according to an embodiment.

FIG. 10 is a view showing antenna characteristics according to first and second variables according to an embodiment.

FIG. 11 is a view showing resonance frequency dispersion characteristics according to the first and second variables.

### MODES OF THE INVENTION

Hereinafter, exemplary embodiments of the present invention will be described in detail with reference to the accompanying drawings, wherein like reference numerals are used to designate identical or similar elements, and redundant description thereof will be omitted. The suffix “module” and “portion” of the components used in the following description are only given or mixed in consideration of ease of preparation of the description, and there is no meaning or role to be distinguished as it is from one another. Also, in the following description of the embodiments of the present invention, a detailed description of related arts will be omitted when it is determined that the gist of the embodiments disclosed herein may be obscured. Also, the accompanying drawings are included to provide a further understanding of the invention, are incorporated in, and constitute a part of this description, and it should be understood that the invention is intended to cover all modifications, equivalents, or alternatives falling within the spirit and scope of the invention.

Terms including ordinals, such as first, second, etc., may be used to describe various components, but the elements are not limited to these terms. The above terms are only used to distinguish one component from another.

When a component is referred to as being “connected” or “joined” to another component, it may be directly connected or joined to the other component, but it should be understood that other component may be present therebetween. When a component is referred to as being “directly connected” or “directly joined” to another component, it should be understood that other component may not be present therebetween.

A singular representation includes a plural representation, unless the context clearly indicates otherwise.

In the present application, terms such as “including” or “having” are used to specify the presence of features, numbers, steps, operations, components, parts, or combinations thereof described in the description. However, it should be understood that the terms do not preclude the presence or addition of one or more other features, numbers, steps, operations, components, parts, or combinations thereof.

Hereinafter, with reference to the attached drawings, an embodiment of the present invention will be described in detail as follows.

Before describing the embodiment, a radar module of a comparative example that is compared with the embodiment will be described.

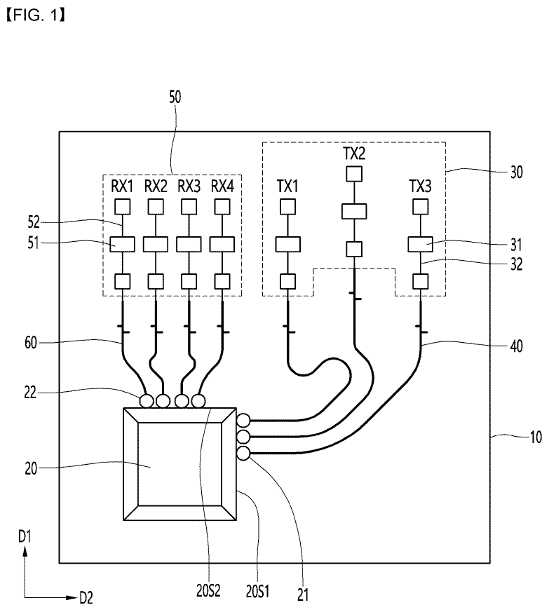

FIG. 1 is a plan view showing a radar module according to a comparative example.

Referring to FIG. 1, the radar module according to the comparative example includes a substrate 10.

In addition, the radar module according to the comparative example includes a radar unit disposed on the substrate 10.

Specifically, the radar module includes a communication device 20 disposed or mounted on the substrate 10. The communication device 20 may also be referred to as a communication chip, a communication IC, an RFIC, etc.

The communication device 20 is disposed on the substrate 10 and controls overall operations of each component that constitutes the radar module. For example, the communication device 20 processes signals of each component that constitutes the radar module.

Specifically, the communication device 20 can generate a transmission signal to be transmitted to an outside and output the generated transmission signal. For example, the communication device 20 can receive a reception signal received from an outside and process the received reception signal.

The communication device 20 may have a hexahedral shape. For example, a planar shape of the communication device 20 is a square shape.

Accordingly, an edge of the upper surface of the communication device 20 includes a first edge portion 20S1 and a second edge portion 20S2. The first edge portion 20S1 may mean a straight line extending in a first direction D1 from an upper surface of the communication device 20. For example, the first edge portion 20S1 may mean a straight line parallel to a left end or right end of a plane of the substrate 10 among the edges of the upper surface of the communication device 20.

In addition, the second edge portion 20S2 may mean a straight line extending in a second direction D2 from the upper surface of the communication device 20. For example, the second edge portion 20S2 may be a straight line extending in a direction perpendicular to the first edge portion 20S1. For example, the second edge portion 20S2 may mean a straight line parallel to an upper end or a lower end of a plane of a substrate 10 among the edges of the upper surface of the communication device 20.

In addition, the communication device 20 includes a plurality of terminals. For example, the communication device 20 includes an antenna terminal connected to an antenna unit of a radar module. The communication device 20 includes a transmitting terminal 21. In addition, the communication device 20 includes a receiving terminal 22. The transmitting terminal 21 is disposed in a plurality of units on the first edge portion 20S1 of the communication device 20. For example, the transmitting terminals 21 are disposed spaced apart from each other in the first direction D1 on the first edge portion 20S1 of the communication device 20. The receiving terminal 22 is disposed in a plurality of units on the second edge portion 20S2 of the communication device 20. For example, the receiving terminals 22 are disposed spaced apart from each other in the second direction D2 on the second edge portion 20S2 of the communication device 20.

In addition, the radar module of the comparative example includes an antenna unit. The antenna unit includes a transmitting antenna unit 30 and a receiving antenna unit 50. The transmitting antenna unit 30 includes a plurality of transmitting antennas. For example, the transmitting antenna unit 30 includes first to third transmitting antennas TX1, TX2, and TX3. The receiving antenna unit 50 includes a plurality of receiving antennas. For example, the receiving antenna unit 50 includes first to fourth receiving antennas RX1, RX2, RX3, and RX4.

The first to third transmitting antennas TX1, TX2, and TX3 include a radiator 31 and a feed line 32 supplying a signal to the radiator 31. At this time, the first to third transmitting antennas TX1, TX2, and TX3 are disposed on the substrate 10 in a direction corresponding to the second direction D2.

At this time, an arrangement direction of the first to third transmitting antennas TX1, TX2, and TX3 means a separation direction of the plurality of radiators constituting each of the first to third transmitting antennas TX1, TX2, and TX3. For example, the arrangement direction of the first to third transmitting antennas TX1, TX2, and TX3 means an extension direction of the feed line 32 constituting each of the first to third transmitting antennas TX1, TX2, and TX3.

The first to third transmitting antennas TX1, TX2, and TX3 are disposed in a direction parallel to the first edge portion 20S1 of the communication device 20. The first to third transmitting antennas TX1, TX2, and TX3 are disposed in a direction perpendicular to the second edge portion 20S2.

In addition, the first to fourth receiving antennas RX1, RX2, RX3, and RX4 include a radiator 51 and a feed line 52 supplying a signal to the radiator 51. At this time, an arrangement direction of the first to fourth receiving antennas RX1, RX2, RX3, and RX4 corresponds to an arrangement direction of the first to third transmitting antennas TX1, TX2, and TX3. That is, the arrangement direction of the first to fourth receiving antennas RX1, RX2, RX3, and RX4 is the second direction D2.

Meanwhile, the radar module includes a transmission line connecting the communication device 20 and the antenna unit. For example, a transmission line 40 is disposed between the communication device 20 and the transmitting antenna unit 30. For example, a transmission line 40 is disposed between each transmitting terminal 21 of the communication device 20 and each transmitting antenna of the transmitting antenna unit 30.

In addition, a reception line 60 is disposed between the communication device 20 and the receiving antenna unit 50. For example, a reception line 60 is disposed between each receiving terminal 22 of the communication device 20 and each receiving antenna of the receiving antenna unit 50.

As described above, the radar module in the comparative example has a structure in which the transmitting antenna unit 30 and the receiving antenna unit 50 are disposed on the substrate 10 in the second direction D2. Accordingly, in the comparative example, there is a problem that an area occupied by the communication device 20, the transmitting antenna unit 30, and the receiving antenna unit 50 on the substrate 10 increases, and a product size increases accordingly. At this time, in order to reduce the product size, if sizes of the transmitting antenna unit 30 and the receiving antenna unit 50 are reduced, the performance of the radar module is drastically reduced accordingly, and it may be difficult to secure the antenna performance of the radar module accordingly.

In addition, the radar module in the comparative example includes a transmission line 40 and a reception line 60. At this time, a length of the transmission line 40 in the comparative example is significantly different from a length of the reception line 60.

Specifically, the receiving antenna unit 50 is disposed adjacent to the communication device 20. In contrast, the transmitting antenna unit 30 is spaced farther away from the communication device 20 than the receiving antenna unit 50. Accordingly, the radar module in the comparative example has a large difference in the length of the reception line 60 and the length of the transmission line 40. Accordingly, the radar module in the comparative example has a large difference in the transmission characteristics and reception characteristics of the signal, and a problem occurs in the overall performance of the radar module due to the difference.

In addition, the length of the transmission line 40 in the comparative example is 25 mm or more. For example, the length of the transmission line 40 in the comparative example is 26 mm or more. For example, the length of the transmission line 40 in the comparative example is 27 mm or more. For example, the length of the transmission line 40 in the comparative example is 28 mm or more. In addition, the signal transmission loss in the radar module increases in proportion to the length of the transmission line 40. Accordingly, in the comparative example, the signal transmission loss exceeds −6 dB.

Accordingly, an embodiment maximizes the antenna performance while maintaining the sizes of the transmitting antenna unit and the receiving antenna unit of the radar module. In addition, the embodiment improves signal transmission characteristics and signal reception characteristics by ensuring that a length of a transmission line and a length of a reception line are similar to each other. In addition, the embodiment can drastically reduce a length of the transmission line compared to the comparative example, thereby minimizing the signal transmission loss accordingly.

Hereinafter, a radar module, a radar device, and a vehicle sensing system according to the embodiment will be described.

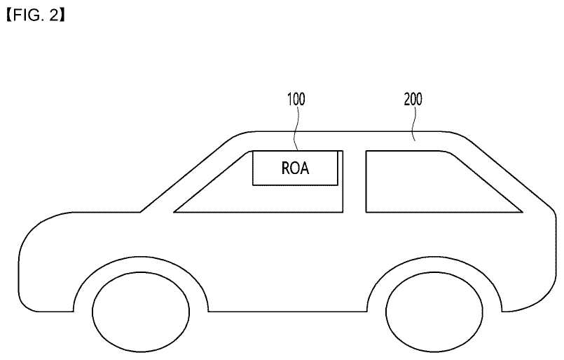

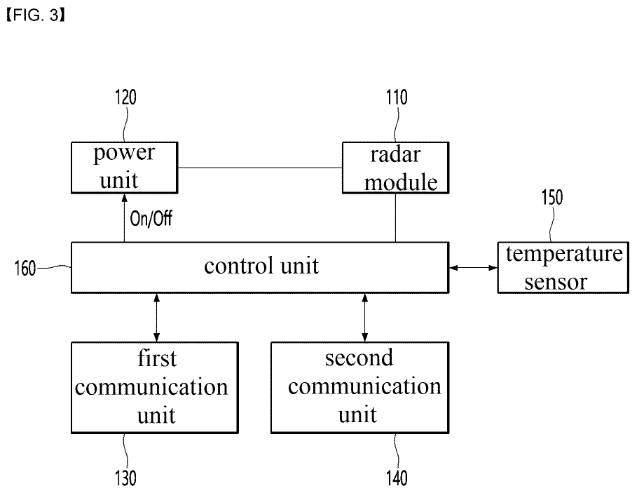

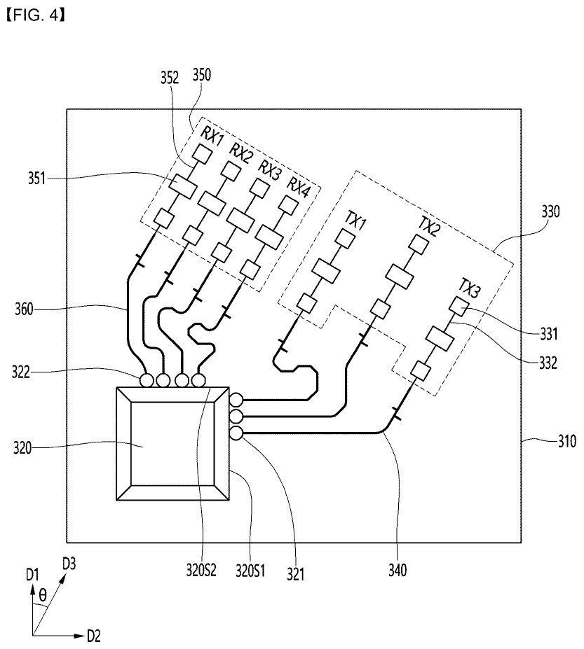

FIG. 2 is a schematic configuration diagram of a vehicle sensing system according to an embodiment, FIG. 3 is a diagram showing a rear occupant alert device of FIG. 2, and FIG. 4 is a detailed configuration diagram of the radar module of FIG. 3. At this time, the radar device including the radar module of the embodiment can perform a rear occupant sensing function. Accordingly, the radar device may also be referred to as a rear occupant alert device (ROA).

That is, the radar module in the embodiment may be an In-Cabin Radar. For example, the radar module and the radar device in the embodiment may be installed inside the vehicle and thus provide various sensing alert information to an user inside the vehicle. For example, the radar device in the embodiment may be installed inside the vehicle and thus provide a rear occupant alert (ROA) function. However, the embodiment is not limited thereto, and the radar device in the embodiment may be equipped to provide other functions in addition to the rear occupancy alert (ROA) function.

That is, the vehicle sensing system may include a vehicle 200 and a rear occupant alert device (ROA) 100 which is a radar device disposed inside the vehicle 200.

The rear occupant alert device (ROA) 100 may be disposed inside the vehicle 200 and may obtain various information inside the vehicle 200.

For example, the rear occupant alert device (ROA) 100 can sense a moving object when the vehicle 200 is in a specific state. For example, the rear occupant alert device (ROA) 100 can be operated under a condition where an engine of the vehicle 200 is turned off and the driver gets out. In addition, the rear occupant alert device (ROA) 100 senses whether there is a moving object inside the vehicle under the condition. For example, the rear occupant alert device (ROA) 100 can sense whether there is a target living being inside the vehicle.

In addition, the rear occupant alert device (ROA) 100 can provide an alert function when the moving object is sensed. For example, the rear occupant alert device (ROA) 100 can transmit information notifying that the moving object has been sensed to the electronic control unit (ECU) of the vehicle 200. For example, the rear occupant alert device (ROA) 100 can transmit information to a pre-registered terminal to notify that the moving object has been sensed.

In addition, the rear occupant alert device (ROA) 100 can optionally output a control signal for controlling the state of the vehicle 200. For example, the rear occupant alert device (ROA) 100 can directly output a signal for vehicle control when there is no vehicle control despite the transmission of the information or when the safety of the sensed object is not secured. For example, the signal for vehicle control can include at least one of a signal for controlling a vehicle air conditioner, a signal for controlling a vehicle instrument panel, a signal for controlling a vehicle lamp, and a signal for controlling a vehicle window.

To this end, the rear occupant alert device (ROA) 100 may include a radar module 110, a power unit 120, a first communication unit 130, a second communication unit 140, a temperature sensor 150, and a control unit 160.

The radar module 110 may include an antenna. For example, the radar module 110 may include a transmitting antenna and a receiving antenna. The transmitting antenna transmits a transmission signal. The receiving antenna receives a reception signal for the transmission signal reflected by an object.

That is, the radar module 110 may sense an object in a surrounding region of an installation location. For example, the radar module 110 may sense a target existing in the surrounding region of the installation location. For example, the radar module 110 may sense an object with movement existing in the surrounding region of the installation location or the movement of an object. For example, the radar module 110 may sense a living being existing in the surrounding region of the installation location.

The radar module 110 senses information about a surrounding environment through electromagnetic waves, and accordingly senses the target, a moving object, or the movement of an object or a living being.

The power unit 120 can perform a power management operation.

For example, the power unit 120 can supply power to each component constituting the rear occupant alert device 100. In addition, the power unit 120 can manage or control the power supplied to each component constituting the rear occupant alert device 100.

For example, the power unit 120 can control the power supplied to the radar module 110. For example, the power unit 120 can block the power supplied to the radar module 110 before the rear occupant alert function is activated. For example, the power unit 120 can supply driving power to the radar module 110 based on an activation of the rear occupant alert function. For example, the power unit 120 controls the power supplied to the radar module 110 based on the control signal of the control unit 160. For example, the power unit 120 can block the power supplied to the radar module 110 until an ignition is turned off and the driver's disembarkation is detected. For example, when the ignition is turned off and the driver's disembarkation is detected, the power unit 120 can supply driving power to the radar module 110 for a certain period of time.

The power unit 120 may be a power management unit (PMIC), but is not limited thereto.

A first communication unit 130 may perform communication with the vehicle 200. Preferably, the first communication unit 130 may perform communication with an ECU of the vehicle 200.

Through this, the first communication unit 130 may include a communication module (not shown) for communication with electronic devices provided in the vehicle. For example, the first communication unit 130 may include a communication module that performs communication based on at least one communication protocol among CAN (Controller Area Network), LIN (Local Interconnection Network), Flex-Ray, Ethernet, etc.

The second communication unit 140 may perform communication with an external device. For example, the second communication unit 140 may perform communication with a pre-registered terminal. For example, the second communication unit 140 can perform communication with a user terminal. For example, the second communication unit 140 can perform communication with a terminal registered by a driver. In addition, the second communication unit 140 can perform communication with a server. For example, the second communication unit 140 can perform communication with a specific server that manages emergency signals and secures user safety based on the emergency signals.

The second communication unit 140 can be a wireless communication unit. For example, the second communication unit 140 can include a module for wireless internet access. For example, the second communication unit 140 is configured to transmit and receive wireless signals in a communication network according to wireless internet technologies.

Wireless Internet technologies may include WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), and LTE-A (Long Term Evolution-Advanced), but is not limited thereto.

Alternatively, the second communication unit 140 may be a short range communication unit. For example, the second communication unit 140 may include a short range communication module. At this time, the short-range communication module can support short-range communication by using at least one of Bluetooth™, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, and Wireless USB (Wireless Universal Serial Bus) technologies.

The rear occupant alert device 100 includes a temperature sensor 150.

The temperature sensor 150 can sense the temperature inside the vehicle. At this time, the temperature sensor 150 can operate in conjunction with the operation of the rear occupant alert device 100. For example, the temperature sensor 150 can perform an operation at a time when a rear occupant alert is required.

For example, the temperature sensor 150 can sense the temperature inside the vehicle when a moving object is sensed through the radar module 110.

The control unit 160 can control the overall operation of the rear occupant alert device 100. For example, the control unit 160 can determine whether the rear occupant alert operation is activated through communication with the ECU of the vehicle 200.

For example, the control unit 180 can receive an activation signal from the ECU of the vehicle 200 when the ignition is turned off and the driver's disembarkation is detected.

In addition, the control unit 180 can drive the radar module 110 for a certain period of time based on the received activation signal. Alternatively, the control unit 160 can drive the radar module 110 until a function-off command is input from the user based on the received activation signal.

The control unit 160 may receive a sensing signal according to the driving of the radar module 110 and determine whether there is an object having movement inside the vehicle.

In addition, when it is determined that the object with the movement exists, the control unit 160 may perform a notification operation therefor.

For example, if the object with movement is sensed, the control unit 160 can transmit information notifying that the object exists to the ECU of the vehicle 200 through the first communication unit 130. In addition, if the object with movement is sensed, the control unit 160 can transmit information notifying that the object exists to a pre-registered terminal through the second communication unit 140.

At this time, the control unit 160 transmits temperature data acquired through the temperature sensor 150 together with information notifying that the object exists to the ECU and the terminal. For example, if the inside of the vehicle is too cold or too hot, a serious problem may occur in the safety of the object. Accordingly, in order to enable an immediate response to this, the control unit 160 can transmit the temperature data to the ECU and the terminal.

Thereafter, the control unit 160 can control the vehicle based on the transmitted information. For example, the control unit 160 can control the vehicle, such as flashing the emergency lights, outputting the instrument panel, and generating the horn sound. At this time, the vehicle control can be performed independently by the control unit 160, or differently, can be performed by the control of the ECU.

For example, if the vehicle control is not performed even after the transmission of the information, the control unit 160 can perform a vehicle control operation independently to ensure the safety of the object.

In addition, the control unit 160 can control a heater operation or an air conditioner operation based on the acquired temperature data during the vehicle control.

In addition, the control unit 160 can perform a window opening operation of the vehicle to ensure the safety of the object.

Hereinafter, an arrangement structure of the radar module 110 will be described in more detail.

Referring to FIG. 4, the radar module 110 may include a substrate 310.

The substrate 310 is a substrate including an electric circuit capable of changing wiring, and may include all of a print, a wiring board, and an insulating substrate made of an insulating material capable of forming circuit pattern layers on a surface.

The radar module 110 includes a communication device 320 disposed on the substrate 310.

The communication device 320 may mean a chip that manages the overall operation of the radar module 110. For example, the communication device 320 may be a millimeter wave RFIC (radio frequency IC), but is not limited thereto.

The communication device 320 may have a function of processing a signal of an antenna unit of the radar module.

For example, the communication device 320 may process a transmission signal to be transmitted to an outside through a transmitting antenna unit 330. For example, the communication device 320 can generate a transmission signal to be transmitted from the transmitting antenna unit 330, amplify the generated transmission signal, and provide the amplified transmission signal to the transmitting antenna unit 330.

In addition, the communication device 320 can process a reception signal received from the outside through the receiving antenna unit 350. For example, the communication device 320 can obtain a reception signal received through the receiving antenna unit 350, and process the obtained reception signal by low-noise amplification. In addition, the communication device 320 can analyze the processed reception signal and obtain object sensing information accordingly.

A planar shape of the communication device 320 may be a square. For example, the planar shape of the communication device 320 may be a rectangle, or may be a square.

Accordingly, an upper surface of the communication device 320 may include a plurality of straight lines.

Preferably, an edge of the upper surface of the communication device 320 may include a first edge portion 320S1 that extends long in a first direction D1. The first edge portion 320S1 may mean a right edge of the upper surface of the communication device 320. For example, the first edge portion 320S1 may mean a portion of the edge of the upper surface of the communication device 320 that is adjacent to a right end of the substrate 310.

The first edge portion 320S1 of the communication device 320 may be a straight portion that extends in the first direction D1 on the substrate 310.

In addition, a transmitting terminal 321 is formed on the first edge portion 320S1 of the communication device 320. For example, a plurality of transmitting terminals 321 may be disposed adjacent to the first edge portion 320S1 of the communication device 320. The transmitting terminals 321 may mean terminals or ports that electrically connect the communication device 320 and the transmitting antenna unit 330.

A number of the transmitting terminals 321 may correspond to a number of the transmitting antenna units 330. For example, the number of the transmitting terminals 321 may correspond to a number of transmission channels of a transmission signal.

For example, the transmission channels of the radar module of the embodiment may include first to third transmission channels. For example, the transmitting antenna unit 330 of the radar module of the embodiment may include first to third transmitting antennas TX1, TX2, and TX3.

Accordingly, the communication device 320 may include three transmitting terminals 321. At this time, the three transmitting terminals 321 may be disposed to be spaced apart from each other on the substrate 310. For example, the three transmitting terminals 321 may be disposed to be spaced apart from each other in the first direction D1 on the substrate 310. Accordingly, the first direction D1 may mean a direction in which the first edge portion 320S1 of the communication device 320 extends and a direction in which the transmitting terminals 321 are spaced apart from each other. In addition, the first direction D1 may mean a direction in which an imaginary straight line connecting centers of the three transmitting terminals 321 extends.

Specifically, the first edge portion 320S1 of the communication device 320 is a straight line extending in the first direction D1 on the first substrate 310.

In addition, a plurality of transmitting terminals 321 are disposed adjacent to the first edge portion 320S1 of the communication device 320. In addition, the plurality of transmitting terminals 321 are disposed to be spaced apart from each other in the first direction D1. For example, an imaginary straight line connecting the centers of the plurality of transmitting terminals 321 may extend in the first direction D1.

In addition, the edge of the upper surface of the communication device 320 may include a second edge portion 320S2 extending in the second direction D2. The second direction D2 means a direction perpendicular to the first direction D1.

The second edge portion 320S2 may refer to a rear side of the upper surface of the communication device 320. For example, the second edge portion 320S2 may refer to a portion of the upper surface of the communication device 320 adjacent to a rear side end of the substrate 310.

The second edge portion 320S2 of the communication device 320 may be a straight portion that extends in the second direction D2 on the substrate 310.

In addition, a receiving terminal 322 is formed on the second edge portion 320S2 of the communication device 320. For example, a plurality of receiving terminals 322 may be disposed adjacent to the second edge portion 320S2 of the communication device 320. The receiving terminal 322 may mean a terminal or port that electrically connects between the communication device 320 and the receiving antenna unit 350.

A number of the receiving terminals 322 may correspond to a number of the receiving antenna units 350 or a number of arrays. For example, the number of the receiving terminals 322 may correspond to a number of transmission channels of the reception signal.

For example, the receiving channels of the radar module of the embodiment may include first to fourth receiving channels. For example, the receiving antenna unit 350 of the radar module of the embodiment may include first to fourth receiving antennas RX1, RX2, RX3, and RX4.

Accordingly, the communication device 320 may include four receiving terminals 322. At this time, the four transmitting terminals 322 may be disposed to be spaced apart from each other on the substrate 310. For example, the four receiving terminals 322 may be disposed spaced apart from each other in the second direction D2 on the substrate 310. Accordingly, the second direction D2 may mean a direction in which the second edge portion 320S2 of the communication device 320 extends and a direction in which the receiving terminals 322 are spaced apart from each other. In addition, the second direction D2 may mean a direction in which an imaginary straight line connecting centers of the four receiving terminals 322 extends.

Specifically, the second edge portion 320S2 of the communication device 320 is a straight line extending in the second direction D2 on the first substrate 310.

In addition, a plurality of receiving terminals 322 are disposed adjacent to the second edge portion 320S2 of the communication device 320. In addition, the plurality of receiving terminals 322 are disposed to be spaced apart from each other in the second direction D2. For example, an imaginary straight line connecting the centers of the plurality of receiving terminals 322 may extend in the second direction D2.

Meanwhile, the radar module 110 includes an antenna unit. For example, the radar module 110 includes a transmitting antenna unit 330 and a receiving antenna unit 350.

The transmitting antenna unit 330 may transmit a transmission signal to the outside.

The receiving antenna unit 350 may receive a reception signal.

For example, when a transmission signal is transmitted from the transmitting antenna unit 330, the transmission signal may be reflected by an object, and a signal reflected by the object may be received as a reception signal of the receiving antenna unit 350.

Meanwhile, the transmitting antenna unit 330 and the receiving antenna unit 350 may be disposed to be elongated in one direction on the substrate 310.

That is, the transmitting antenna unit 330 includes a plurality of transmitting antennas, and each of the plurality of transmitting antennas may be disposed to be elongated in one direction on the substrate 310.

In addition, the receiving antenna unit 350 includes a plurality of receiving antennas, and each of the plurality of receiving antennas may be disposed to be elongated in one direction on the substrate 310.

At this time, the transmitting antenna unit and the receiving antenna unit in the comparative example are disposed to be elongated in the first direction D1, which is the direction corresponding to the first edge portion of the communication device. In addition, the transmitting antenna unit and the receiving antenna unit in the comparative example are disposed to be elongated in a direction perpendicular to the second direction D2, which is a direction in which the second edge portion of the communication device is arranged. Accordingly, in the comparative example, the arrangement area of the communication device, the transmitting antenna unit, and the receiving antenna unit on the substrate increased, and an overall size of the radar module has increased due to the decrease in the usability of the arrangement space. Furthermore, in the comparative example, the antenna performance is deteriorated due to the difference in length between the transmission line connected to the transmitting antenna unit and the reception line connected to the receiving antenna unit.

Differently, in the embodiment, the transmitting antenna unit 330 and the receiving antenna unit 350 are disposed to rotate at a certain angle (Θ) based on the communication device 320.

For example, in the embodiment, a direction in which the transmitting antenna unit 330 and the receiving antenna unit 350 are disposed may be a third direction D3 rather than the first direction D1 and the second direction D2, unlike the comparative example.

Preferably, an extension direction or arrangement direction of each of the plurality of transmitting antennas constituting the transmitting antenna unit 330 in the embodiment may be different from the first direction D1 and the second direction D2.

In addition, an extension direction or arrangement direction of each of the plurality of receiving antennas constituting the receiving antenna unit 350 in the embodiment may be different from the first direction D1 and the second direction D2.

Preferably, each of the plurality of transmitting antennas and the plurality of receiving antennas in the embodiment may be disposed to extend in a third direction D3 between the first direction D1 and the second direction D2 on the substrate 310. For example, the third direction D3 may be a direction rotated by a certain angle (Θ) from the first direction D1 toward the second direction D2.

Accordingly, the extension direction or arrangement direction of each of the plurality of transmitting antennas constituting the plurality of transmitting antenna units 330 in the embodiment may be different from an extension direction of the first edge portion 320S1 of the communication device 320 and an extension direction of the transmitting terminal 321. In the embodiment, an extension direction or arrangement direction of each of the plurality of transmitting antennas constituting the plurality of transmitting antenna units 330 may not be perpendicular to an extension direction of the second edge portion 320S2 of the communication device 320 and an extension direction of the receiving terminal 322.

In addition, an extension direction or arrangement direction of each of the plurality of receiving antennas constituting the plurality of receiving antenna units 350 in the embodiment may be different from an extension direction of the first edge portion 320S1 of the communication device 320 and an extension direction of the transmitting terminal 321. The extension direction or arrangement direction of each of the plurality of receiving antennas constituting the plurality of receiving antenna units 350 in the embodiment may not be perpendicular to the extension direction of the second edge portion 320S2 of the communication device 320 and the extension direction of the receiving terminal 322.

Before explaining a relationship between the arrangement direction of the communication device 320 and the arrangement direction of the transmitting antenna unit 330 and the receiving antenna unit 350, a definition of the arrangement direction of the transmitting antenna unit 330 and the receiving antenna unit 350 will first be explained.

The transmitting antenna unit 330 includes a plurality of transmitting antennas.

For example, the transmitting antenna unit 330 includes first to third transmitting antennas TX1, TX2, and TX3 respectively. For example, the transmitting terminal 321 of the communication device 320 may include first to third transmitting terminals. In addition, the transmitting antenna unit 330 may include a first transmitting antenna TX1 connected to the first transmitting terminal, a second transmitting antenna TX2 connected to the second transmitting terminal, and a third transmitting antenna TX3 connected to the third transmitting terminal.

In addition, the arrangement direction of the transmitting antenna unit 330 may mean a direction in which the first transmitting antenna TX1 is arranged, the direction in which the second transmitting antenna TX2 is arranged, and the direction in which the third transmitting antenna TX3 is arranged. That is, the first transmitting antenna TX1, the second transmitting antenna TX2, and the third transmitting antenna TX3 may be disposed in a same direction. That is, the first transmitting antenna TX1, the second transmitting antenna TX2, and the third transmitting antenna TX3 may be disposed to extend toward the third direction D3, which is the same direction as each other.

Specifically, each of the first transmitting antenna TX1, the second transmitting antenna TX2, and the third transmitting antenna TX3 includes a plurality of first radiators 331 and a first feed line 332 connected to the plurality of first radiators 331.

In addition, the arrangement direction of the first transmitting antenna TX1 may mean a separation direction of the plurality of first radiators constituting the first transmitting antenna TX1. For example, the arrangement direction of the first transmitting antenna TX1 may mean an extension direction of the first feed line 332 constituting the first transmitting antenna TX1.

The arrangement direction of the second transmitting antenna TX2 may mean a separation direction of the plurality of first radiators constituting the second transmitting antenna TX2. For example, the arrangement direction of the second transmitting antenna TX2 may mean an extension direction of the first feed line 332 constituting the second transmitting antenna TX2.

The arrangement direction of the third transmitting antenna TX3 may mean a separation direction of the plurality of first radiators constituting the third transmitting antenna TX3. For example, the arrangement direction of the third transmitting antenna TX3 may mean an extension direction of the first feed line 332 constituting the third transmitting antenna TX3.

In addition, the first transmitting antenna TX1, the second transmitting antenna TX2, and the third transmitting antenna TX3 may be disposed to be spaced apart from each other in a fourth direction (not shown) perpendicular to the third direction D3 and extended in the third direction D3.

At this time, the first transmitting antenna TX1, the second transmitting antenna TX2, and the third transmitting antenna TX3 may have different sensing regions. For example, arrangement positions of the first transmitting antenna TX1, the second transmitting antenna TX2, and the third transmitting antenna TX3 on the substrate 310 may be different from each other. For example, the second transmitting antenna TX2 is disposed between the first transmitting antenna TX1 and the third transmitting antenna TX3 on the substrate 310. In addition, the first radiators of each of the first transmitting antenna TX1 and the third transmitting antenna TX3 may overlap in a fourth direction perpendicular to the third direction D3. In contrast, the first radiator of the second transmitting antenna TX2 may not overlap with the first radiators of the first transmitting antenna TX1 and the third transmitting antenna TX3 in the fourth direction. For example, the first radiator of the second transmitting antenna TX2 may be disposed farther away in the third direction D3 from the positions of the first radiators of the first transmitting antenna TX1 and the third transmitting antenna TX3 on the substrate 310.

Meanwhile, the receiving antenna unit 350 includes a plurality of receiving antennas.

For example, the receiving antenna unit 350 includes first to fourth receiving antennas RX1, RX2, RX3, and RX4. For example, the receiving terminal 322 of the communication device 320 may include first to fourth receiving terminals.

In addition, the receiving antenna unit 350 may include a first receiving antenna RX1 connected to the first receiving terminal, a second receiving antenna RX2 connected to the second receiving terminal, a third receiving antenna RX3 connected to the third receiving terminal, and a fourth receiving antenna RX4 connected to the fourth receiving terminal.

In addition, an arrangement direction of the receiving antenna unit 350 may mean a direction in which the first receiving antenna RX1 is arranged, a direction in which the second receiving antenna RX2 is arranged, a direction in which the third receiving antenna RX3 is arranged, and a direction in which the fourth receiving antenna RX4 is arranged. That is, the first receiving antenna RX1, the second receiving antenna RX2, the third receiving antenna RX3, and the fourth receiving antenna RX4 may be disposed in a same direction. That is, the first receiving antenna RX1, the second receiving antenna RX2, the third receiving antenna RX3, and the fourth transmitting antenna RX4 may be disposed to extend toward the third direction D3 which is the same direction as each other. In addition, the first receiving antenna RX1, the second receiving antenna RX2, the third receiving antenna RX3, and the fourth receiving antenna RX4 may be disposed to extend toward the third direction D3 which is the same direction as the direction in which the first transmitting antenna TX1, the second transmitting antenna TX2, and the third transmitting antenna TX3 are disposed or extended.

Specifically, each of the first receiving antenna RX1, the second receiving antenna RX2, the third receiving antenna RX3, and the fourth receiving antenna RX4 includes a plurality of second radiators 351 and a second feed line 352 connected to the plurality of second radiators 351.

In addition, an arrangement direction of the first receiving antenna RX1 may mean a separation direction of the plurality of second radiators constituting the first receiving antenna RX1. For example, the arrangement direction of the first receiving antenna RX1 may mean an extension direction of the second feed line 352 constituting the first receiving antenna RX1.

In addition, an arrangement direction of the second receiving antenna RX2 may mean a separation direction of the plurality of second radiators constituting the second receiving antenna RX2. For example, the arrangement direction of the second receiving antenna RX2 may mean an extension direction of the second feed line 352 constituting the second receiving antenna RX2.

In addition, an arrangement direction of the third receiving antenna RX3 may mean a separation direction of the plurality of second radiators constituting the third receiving antenna RX3. For example, the arrangement direction of the third receiving antenna RX3 may mean an extension direction of the second feed line 352 constituting the third receiving antenna RX3.

In addition, an arrangement direction of the fourth receiving antenna RX4 may mean a separation direction of the plurality of second radiators constituting the fourth receiving antenna RX4. For example, the arrangement direction of the fourth receiving antenna RX4 may mean an extension direction of the second feed line 352 constituting the fourth receiving antenna RX4.

In addition, the first receiving antenna RX1, the second receiving antenna RX2, the third receiving antenna RX3, and the fourth receiving antenna RX4 may be disposed to extend in the third direction D3 while being spaced apart from each other in a fourth direction (not shown) perpendicular to the third direction D3. Accordingly, the first receiving antenna RX1, the second receiving antenna RX2, the third receiving antenna RX3, the fourth receiving antenna RX4, the first transmitting antenna TX1, the second transmitting antenna TX2, and the third transmitting antenna TX3 may be disposed to be spaced apart from each other in the fourth direction, respectively, and extended or disposed side by side in the third direction D3.

In addition, the third direction D1 means a direction between the first direction D1 and the second direction D2.

For example, the third direction D3 may mean a direction rotated by a certain angle (Θ) in a clockwise direction based on the first direction D1. For example, the third direction D3 may mean a direction rotated by a certain angle (90-Θ) in the clockwise direction based on the second direction D2.

The embodiment determines the angle (Θ) so as to have antenna performance according to optimal antenna design conditions.

At this time, the angle (Θ) can be determined as an optimal length condition of the transmission line 340 disposed between the transmitting antenna unit 330 and the communication device 320 and the reception line 360 disposed between the receiving antenna unit 350 and the communication device 320.

Specifically, the transmission line 340 and the reception line 360 are disposed on the substrate 310.

The transmission line 340 can electrically connect the transmitting terminal 321 of the communication device 320 and the transmitting antenna unit 330. The transmission line 340 can have a function of transmitting a transmission signal or transmitting power to the transmitting antenna unit 330.

The transmission line 340 can be plural. For example, the transmission line 340 may include a first transmission line connecting the first transmitting terminal and the first transmitting antenna TX1. For example, the transmission line 340 may include a second transmission line connecting the second transmitting terminal and the second transmitting antenna TX2. For example, the transmission line 340 may include a third transmission line connecting the third transmitting terminal and the third transmitting antenna TX3.

In addition, the reception line 360 may be plural. For example, the reception line 360 may include a first reception line connecting the first receiving terminal and the first receiving antenna RX1. For example, the reception line 360 may include a second reception line connecting the second receiving terminal and the second receiving antenna RX2. For example, the reception line 360 may include a third reception line connecting between the third receiving terminal and the third receiving antenna RX3. For example, the reception line 360 may include a fourth reception line connecting between the fourth receiving terminal and the fourth receiving antenna RX4.

In addition, the embodiment determines the angle (Θ) so that a difference in length of each of the first transmission line, the second transmission line, the third transmission line, the first reception line, the second reception line, the third reception line, and the fourth reception line can be minimized.

The angle (Θ) may mean an internal angle between the first direction D1 and the third direction D3.

The angle (Θ) may be 45 degrees or less. If the angle (Θ) exceeds 45 degrees, a length of each of the first to fourth reception lines may increase compared to a conventional method, while the decrease in the length of each of the first to third transmission lines may be insignificant compared to the conventional method.

In addition, the angle (Θ) may be 30 degrees or more. If the angle (Θ) is less than 30 degrees, the decrease in the difference between the length of each of the first to fourth reception lines and the length of each of the first to third transmission lines may be insignificant compared to the conventional method, and the improvement in antenna performance due to this may not be significantly different from the conventional method.

Accordingly, the angle (Θ) in the embodiment is set to have a range between 30 degrees and 45 degrees. For example, the angle (Θ) in the embodiment is set to have a range between 32 degrees and 43 degrees. For example, the angle (Θ) in the embodiment is set to have a range between 33 degrees and 42 degrees.

For example, the embodiment has a structure in which the transmitting antenna unit 330 and the receiving antenna unit 350 are disposed with a certain rotation based on the angle (Θ), thereby minimizing the length of the transmission line 340 and the length of the reception line 360. For example, the length of the transmission line in the comparative example exceeds 150% of the length of the reception line. For example, the length of the transmission line in the comparative example exceeds 160% of the length of the reception line. For example, the length of the transmission line in the comparative example exceeds 170% of the length of the reception line. For example, the length of the transmission line in the comparative example exceeds 185% of the length of the reception line.

Unlike this, the embodiment can have the length of the transmission line 340 be 140% or less of the length of the reception line 360 due to the rotation of the angle (Θ). For example, in the embodiment, the length of the transmission line 340 may be 130% or less of the length of the reception line 360 by the rotation of the angle (Θ). For example, in the embodiment, the length of the transmitting antenna unit 330 may be 120% or less of the length of the reception line 360 by the rotation of the angle (Θ).

Accordingly, the embodiment can minimize the difference in length between the first to third transmission lines and the first to fourth reception lines, and can improve the performance of the antenna accordingly. In addition, the embodiment can reduce the length of the first to third transmission signals compared to the comparative example, and can minimize the signal transmission loss accordingly. Furthermore, the embodiment can increase the space utilization on the substrate 310 by arranging the transmitting antenna unit 330 and the receiving antenna unit 350 in a state of being rotated by a certain angle (Θ) as described above.

For example, in the comparative example, the transmitting antenna unit and the receiving antenna unit are disposed entirely in an upper left and upper right areas of a planar region of the substrate. Accordingly, in the comparative example, the degree of freedom in design according to the antenna arrangement is not secured, and thus, there is difficulty in antenna design.

Unlike this, in the embodiment, the transmitting antenna unit 330 and the receiving antenna unit 350 are disposed by rotating based on the angle (Θ). Accordingly, in the embodiment, the transmitting antenna unit 330 and the receiving antenna unit 350 are not disposed in upper left and upper right regions of the planar region of the substrate 310. Accordingly, the embodiment can utilize the space in the upper left and upper right regions of the substrate 310 to allow for arrangement of additional configurations. Accordingly, the embodiment can improve the degree of freedom in designing the antenna arrangement structure, and thus provide ease of antenna design.

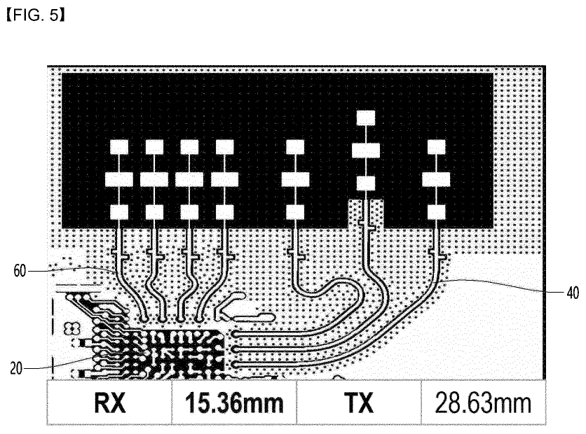

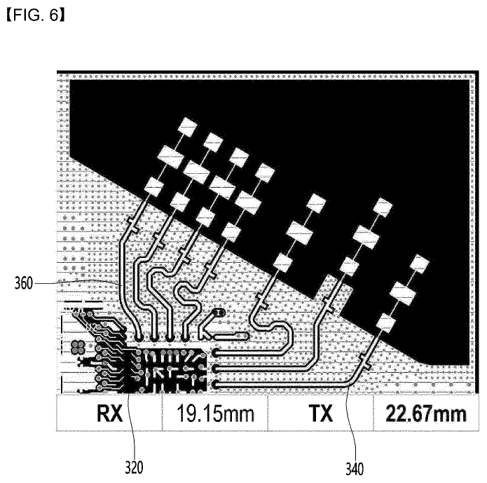

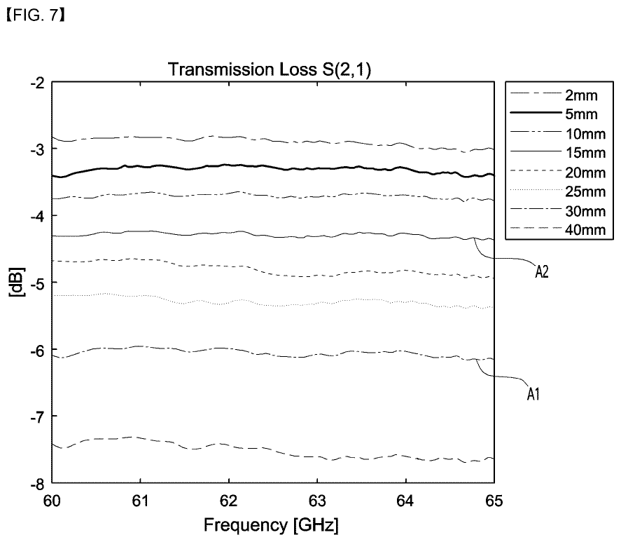

FIG. 5 is a diagram explaining lengths of transmission lines and reception lines of a radar module according to a comparative example, FIG. 6 is a diagram explaining lengths of transmission lines and reception lines of a radar module according to an embodiment, and FIG. 7 is a diagram showing signal transmission loss according to line length.

Referring to FIG. 5, in the radar module of the comparative example, the transmitting antenna unit and the receiving antenna unit are disposed in the same direction as the first direction D1 and in the direction perpendicular to the second direction D2. Accordingly, the length of the transmission line 40 in the comparative example was approximately 28.63 mm, and the length of the reception line 50 was approximately 15.36 mm. For example, the length of the transmission line 40 in the comparative example was approximately 185% of the length of the reception line 60. Accordingly, the comparative example has a problem in that the antenna performance was deteriorated due to the difference between the reception line and the transmission line.

Meanwhile, referring to FIG. 6, in the embodiment, the radar module includes the transmitting antenna unit 330 and the receiving antenna unit 350 arranged in a third direction D3 between the first direction D1 and the second direction D2. For example, in the embodiment, the transmitting antenna unit 330 and the receiving antenna unit 350 are disposed in a third direction D3 rotated by an angle (Θ) ranging from 30 degrees to 45 degrees in clockwise direction based on the first direction D1. Accordingly, the embodiment can minimize the difference in length between the transmission line 340 and the reception line 360.

For example, the length of the transmission line 340 in the embodiment is about 22.67 mm, and the length of the reception line 360 is about 19.15 mm. Specifically, the length of the transmission line 340 in the embodiment may be 140% or less, 130% or less, or 125% or less, or 120% or less of the length of the reception line 360.

Also, referring to FIG. 7, it was confirmed that the signal transmission loss according to the length of the transmission line and the length of the reception line in the comparative example was about −6 dB.

In contrast, it was confirmed that the signal transmission loss according to the length of the transmission line 340 and the length of the reception line 360 in the embodiment was about −4.2 dB, and it was confirmed that the antenna characteristics and performance were improved compared to the comparative example.

Meanwhile, a radar device including such a radar module is installed inside a vehicle. At this time, the radar device is fixed in an installation location inside the vehicle. For example, the radar device can be installed in two locations.

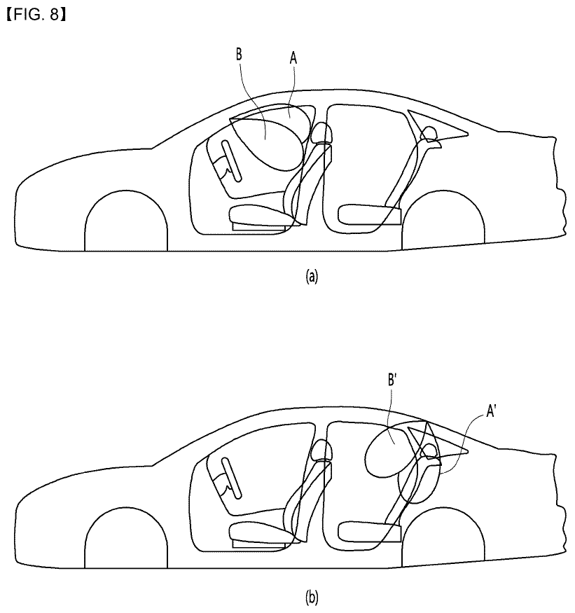

FIG. 8 is a view for comparing beam directions of radar devices according to a comparative example and an embodiment.

Referring to (a) of FIG. 8, the radar device can be installed on the rearview mirror of the vehicle. For example, the radar device can be fixedly installed in a region adjacent to a rearview mirror of the vehicle. Accordingly, even if an antenna beam direction of the radar device is optimally designed, the antenna beam can be formed in a direction other than a direction toward the object depending on a location where the radar device is installed.

As shown in (a) of FIG. 8, in the comparative example, since the radar device is fixedly installed at the rearview mirror of the vehicle, the antenna beam formed by the radar device is formed (A) in an upward direction of the seat, not in the direction of the seat where the object is located. Accordingly, the embodiment changes a structure of the antenna unit of the radar module of the radar device so that even if the radar device is fixedly installed at the rearview mirror, it is formed (B) in the direction of the seat where the object is located.

In addition, referring to (b) of FIG. 8, the radar device can be installed at a vehicle roof. In addition, the radar device may look at various structures inside the vehicle depending on the installation location, and thus the sensing performance may be deteriorated. For example, as in (b) of FIG. 8, the radar device may form an antenna beam (A′) in a direction below the seat instead of toward the seat. Accordingly, the embodiment changes the structure of the antenna unit of the radar module of the radar device so that even if the radar device is fixedly installed at the vehicle roof, it is formed (B′) in a direction of the seat where the object is located.

At this time, in the embodiment, a variable for adjusting the beam direction of the radar module includes a first variable related to the feeding slot and a second variable related to a stub.

In addition, the embodiment allows a direction of the beam generated from the radar module to be controlled by adjusting at least one of the first variable and the second variable.

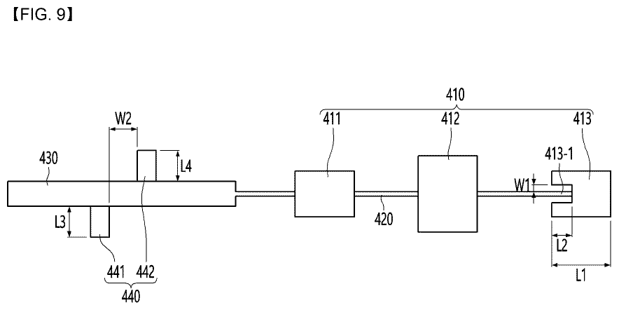

FIG. 9 is a view showing an antenna structure of a radar module according to an embodiment.

Here, the antenna structure of FIG. 9 may represent at least one of the transmitting antenna unit 330 and the receiving antenna unit 350 of FIG. 4. Preferably, the transmitting antenna unit 330 and the receiving antenna unit 350 of the embodiment may have the same structure. For example, all of the first transmitting antenna TX1, the second transmitting antenna TX2, the third transmitting antenna TX3, the first receiving antenna RX1, the second receiving antenna RX2, the third receiving antenna RX3, and the fourth receiving antenna RX4 may have the same structure. In addition, the first transmitting antenna TX1, the second transmitting antenna TX2, the third transmitting antenna TX3, the first receiving antenna RX1, the second receiving antenna RX2, the third receiving antenna RX3, and the fourth receiving antenna RX4 may have the structure illustrated in FIG. 9.

Referring to FIG. 9, the antenna unit may include a radiator 410 and a feeding line 420. The radiator 410 may refer to the first radiator of the transmitting antenna unit described previously, and may refer to the second radiator of the receiving antenna.

In addition, the antenna unit includes a connection line 430 connecting between the communication device 320 and the feeding line 420. At this time, the connection line 430 may refer to a transmission line connected to the transmitting antenna, and may refer to a reception line connected to the receiving antenna.

The radiator 410 may be configured in a plurality of units. For example, the radiator 410 includes a first radiator 411, a second radiator 412, and a third radiator 413 from a region adjacent to the connection line 430.

For example, the first radiator 411 may be a radiator positioned most adjacent to the connection line 430 among the radiators 410. And, the third radiator 413 may be a radiator positioned most distant from the connection line 430 among the radiators 410. And, the second radiator 412 may be a radiator positioned between the first radiator 411 and the third radiator 413.

At this time, the radiator 410 in the embodiment includes a feeding slot 413-1 formed in the third radiator 413 furthest away from the connection line 430. Preferably, the radiator 410 in the embodiment includes an inset feeding slot formed in the third radiator 413. In addition, the embodiment allows a direction of the antenna beam of the radar module to be adjusted by adjusting a size of the feeding slot 413-1.

For example, the feeding slot 413-1 affects the impedance of the radiator 410. In addition, generally, the impedance matching of the radar module is performed using the feeding slot 413-1. At this time, the embodiment performs impedance mismatching of the radar module using the feeding slot 413-1, and adjusts the directionality of the antenna beam by the impedance mismatching.

Specifically, the embodiment disperses a resonant frequency of the antenna by changing a size of the feeding slot 413-1. In addition, as the resonant frequency is dispersed, a direction of the beam radiated from the antenna can be adjusted.

The first variable related to the above-mentioned feeding slot 413-1 includes a length L2 and width W1 of the feeding slot 413-1.

At this time, the length L2 of the feeding slot 413-1 may mean a width or length of the feeding slot 413-1 in a direction in which the feed line 420 extends.

In addition, the width W1 of the feeding slot 413-1 may mean a length or width of the feeding slot 413-1 in a direction perpendicular to the direction in which the feed line 420 extends.

That is, the embodiment disperses the resonant frequency of the antenna by adjusting the length L2 of the feeding slot 413-1 in one direction and the width W1 in the other direction perpendicular to the one direction. And, the direction of the beam radiated from the antenna is adjusted by dispersing the resonant frequency. For example, in the embodiment, when the direction of the beam radiated from the antenna is directed downward from a target direction, the length L2 and width W1 of the feeding slot 413-1 are adjusted so that the direction of the beam can move upward corresponding to the target direction.

At this time, the length L2 of the feeding slot 413-1 in the embodiment is made smaller than the length of the radiator 410. Preferably, the length L2 of the feeding slot 413-1 is made smaller than the length L1 of the third radiator 413. Preferably, the embodiment is made so that the length L2 of the feeding slot 413-1 has a range of 15% to 50% of the length L1 of the third radiator 413. If the length L2 of the above-described feeding slot 413-1 is less than 15% of the length L1 of the third radiator 413, the degree of control of the direction of the radiation beam is insufficient, and thus the object sensing accuracy may deteriorate. For example, the antenna performance may deteriorate. In addition, if the length L2 of the above-described feeding slot 413-1 exceeds 50% of the length L1 of the third radiator 413, as the degree of dispersion of the resonant frequency increases, the degree of impedance mismatch may become severe. For example, if the length L2 of the above-described feeding slot 413-1 exceeds 50% of the length L1 of the third radiator 413, the antenna performance may actually deteriorate. Accordingly, the embodiment allows the length L2 of the feeding slot 413-1 to have a range of 15% to 50% of the length L1 of the third radiator 413.

The embodiment allows the directionality of the beam radiated from the antenna to be adjusted by adjusting the length L2 and width W1 of the feeding slot 413-1 as described above. At this time, the length L2 and width W1 of the feeding slot 413-1 are variables that affect the impedance of the antenna, and the antenna characteristics may be degraded by adjusting only these.

Accordingly, the embodiment allows the antenna performance to be improved by adjusting the second variable related to the stub 440 along with the first variable for the feeding slot 413-1 to adjust the directionality of the beam. The second variable related to the stub 440 is a variable that affects an electrical length of the antenna.

For example, the embodiment includes a stub 440 formed on the connection line 430. The stub 440 may be arranged in multiples at a predetermined spacing.

For example, the stub 440 includes a first stub 441 arranged on one side of the connection line 430 and a second stub 442 spaced apart from the first stub 441 in one direction. At this time, the second stub 442 may be arranged to extend in a different direction from the first stub 440 on the connection line 430.

For example, the first stub 441 is arranged on one side of the connection line 430. And, the second stub 442 is arranged on the other side of the connection line 430 opposite to the one side.

At this time, in the embodiment, the directionality of the beam radiated from the antenna can be adjusted by adjusting the second variable related to the stub 440 and the antenna performance can be improved.

In addition, in the embodiment, the directionality of the beam can be adjusted by adjusting the length of the stub 440. At this time, in the case of the stub 440 being composed of a plurality of units, the directionality of the beam can be adjusted by adjusting the length L3 of the first stub 440 and the length L4 of the second stub 442, and the antenna performance can be improved.

Furthermore, the embodiment allows the directionality of the beam to be adjusted by adjusting the spacing W2 between the first stub 441 and the second stub 442 when the stub 440 is configured in a plurality of units.

In conclusion, the embodiment may have a problem in that the antenna performance deteriorates depending on the installation location since the antenna is installed in a fixed location. For example, the direction of the beam radiated from the antenna may be in a direction other than the target direction. Accordingly, the embodiment allows the direction of the beam of the antenna to correspond to the target direction even when the antenna is installed in a fixed location by adjusting the first variable related to the feeding slot and the second variable related to the stub. At this time, the first variable may include the length and width of the feeding slot. In addition, the second variable related to the stub includes the length of the stub. At this time, when the stub is configured in a plurality of units, the second variable includes the lengths of each of the first and second stubs. The second variable includes a spacing between the first stub and the second stub.

Accordingly, the embodiment can improve antenna performance by adjusting the first and second variables as described above so that the direction of the beam radiated from the antenna corresponds to the target direction. Furthermore, the embodiment can improve object sensing accuracy and user satisfaction accordingly by adjusting the direction of the beam to correspond to the target direction.

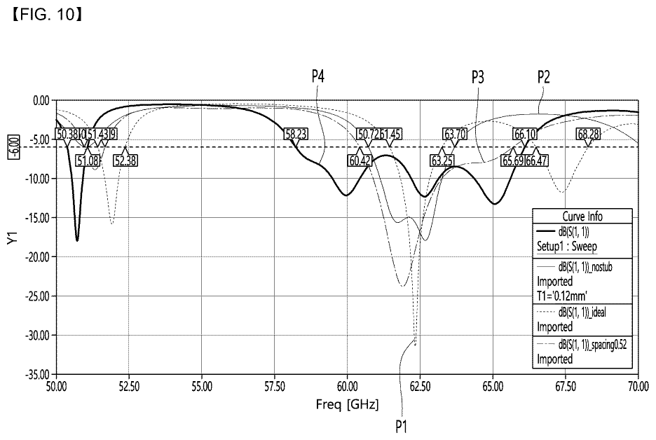

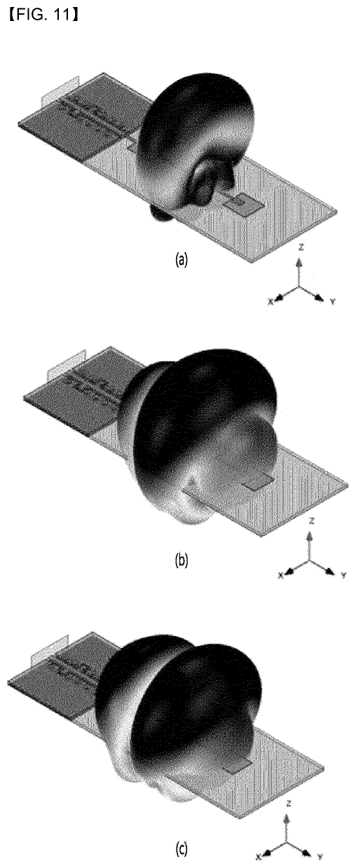

FIG. 10 is a view showing antenna characteristics according to first and second variables according to an embodiment, and FIG. 11 is a view showing resonance frequency dispersion characteristics according to the first and second variables.

Referring to FIG. 10, the embodiment was able to confirm that it is possible to implement a radar module having different beam characteristics by adjusting the first and second variables.

For example, a first characteristic (P1) of FIG. 10 shows beam characteristics in a state where the antenna unit does not include a feeding slot and a stub. In addition, a second characteristic (P2) of FIG. 10 shows the beam characteristic when only the first variable corresponding to the feeding slot of the antenna unit is adjusted. In addition, a third characteristic (P3) of FIG. 10 shows the change in the beam characteristic through variable adjustment in a structure including a feeding slot and one stub. In addition, a fourth characteristic (P4) of FIG. 10 shows the change in the beam characteristic through variable adjustment in a structure including a feeding slot and two stubs.

As shown in FIG. 10, when the first variable corresponding to the feeding slot 413-1 and the second variable of the stub 440 including the first stub 441 and the second stub 442 are adjusted, it was confirmed that the resonance frequency was dispersed, and it was confirmed that the beam direction changed accordingly.

For example, to explain the fourth characteristic (P4) in detail, it was confirmed that the beam was radiated only to the center at the resonance frequency of 60 GHz, as shown in (a) of FIG. 11. In addition, it was confirmed that a high-intensity beam was radiated from the center at the resonant frequency of 62 GHz, and a relatively low-intensity beam was radiated from both sides, as shown in (b) of FIG. 11. In addition, it was confirmed that at a resonance frequency of 63.75 GHz, a beam of relatively low intensity was radiated from the center, and a beam of relatively high intensity was radiated from both sides, as shown in (c) of FIG. 11.

In conclusion, it was confirmed that the resonant frequency could be dispersed by adjusting the first and second variables in the embodiment, and accordingly, the direction of the beam could be changed while maintaining antenna performance.

The embodiment includes a radar module. The radar module includes a communication device and an antenna unit. At this time, since the antenna unit of the radar module is installed in a fixed position, there may be a problem that the antenna performance deteriorates depending on an installation position. For example, a direction of a beam radiated from the antenna unit may be a direction other than a target direction. Accordingly, the embodiment allows a direction of a beam of the antenna unit to correspond to the target direction by adjusting a first variable related to a feeding slot and a second variable related to a stub even when the antenna unit is installed in a fixed position. At this time, the first variable may include a length and a width of the feeding slot. In addition, the second variable related to the stub includes a length of the stub. At this time, when the stub is composed of a plurality of pieces, the second variable includes lengths of each of the first and second stubs. The second variable includes a spacing between the first stub and the second stub.

Accordingly, the embodiment can allow the direction of the beam radiated from the antenna unit to correspond to the target direction by adjusting the first and second variables as described above, thereby improving the antenna performance accordingly. Furthermore, the embodiment can improve the sensing accuracy of the object as the direction of the beam corresponds to the target direction, thereby improving user satisfaction accordingly.

Meanwhile, the antenna unit includes a transmitting antenna unit and a receiving antenna unit. In addition, the embodiment allows characteristics of the transmitting antenna unit to correspond to characteristics of the receiving antenna unit. For example, values for the first and second variables of the transmitting antenna unit can be substantially the same as values for the first and second variables of the receiving antenna unit. Accordingly, the embodiment can maintain both the transmitting characteristics and the receiving characteristics of the antenna unit, thereby improving the overall performance of the radar module.

Meanwhile, the communication device in the embodiment includes a plurality of transmitting terminals spaced apart in a first direction and a plurality of receiving terminals spaced apart in a second direction perpendicular to the first direction. At this time, each of the transmitting antenna unit and the receiving antenna unit in the embodiment is disposed in a third direction different from the first direction and the second direction.

For example, a conventional technology includes the transmitting antenna unit and the receiving antenna unit disposed in a same direction as the first direction or the second direction. Accordingly, conventional technology has a problem of deteriorating overall antenna performance. For example, the conventional technology had a problem in that a difference in length between a transmission line connected to the transmitting antenna and a reception line connected to the receiving antenna increased, and thus the signal transmission loss increased. In addition, the conventional technology has a problem that the space utilization for arranging the transmitting and receiving antenna units on the substrate is reduced due to an arrangement structure of the antenna unit as described above. Furthermore, the conventional technology has a problem in that the degree of design freedom for antenna arrangement is low, and thus the ease of design is deteriorated.

In contrast, the embodiment arranges the transmitting antenna unit and the receiving antenna unit in a third direction between the first direction and the second direction as described above. Through this, the embodiment can minimize a difference in length between the transmission line and the reception line, and can minimize the signal transmission loss. Furthermore, the embodiment can improve the overall antenna performance by minimizing the signal transmission loss. In addition, the embodiment can improve space utilization for the arrangement of the transmitting antenna unit and the receiving antenna unit on the substrate. Furthermore, the embodiment can improve the design freedom for the antenna arrangement, and can easily design the antenna.

The characteristics, structures and effects described in the embodiments above are included in at least one embodiment but are not limited to one embodiment. Furthermore, the characteristic, structure, and effect illustrated in each embodiment may be combined or modified for other embodiments by a person skilled in the art. Thus, it would be construed that contents related to such a combination and such a modification are included in the scope of the present invention.

Embodiments are mostly described above. However, they are only examples and do not limit the present invention. A person skilled in the art may appreciate that several variations and applications not presented above may be made without departing from the essential characteristic of embodiments. For example, each component particularly represented in the embodiments may be varied. In addition, it should be construed that differences related to such a variation and such an application are included in the scope of the present invention defined in the following claims.

1-10. (canceled)

11. A radar module comprising:
a substrate;
a communication device disposed on the substrate;
an antenna unit disposed on the substrate; and
a connection line disposed on the substrate and connecting the communication device and the antenna unit, and including at least one stub,
wherein the antenna unit includes a transmitting antenna unit and a receiving antenna unit,
wherein each of the transmitting antenna unit and the receiving antenna unit includes:
a radiator including a feeding slot; and
a feeding line connecting the connection line and the radiator,
wherein a direction of a beam radiated from at least one of the transmitting antenna unit and the receiving antenna unit is adjusted by controlling a first variable related to the feeding slot and a second variable related to the stub, and
wherein at least one of the first variable and the second variable in the transmitting antenna unit is same as at least one of the first variable and the second variable in the receiving antenna unit.

12. The radar module of claim 11, wherein the first variable in the transmitting antenna unit is same as the first variable in the receiving antenna unit.

13. The radar module of claim 12, wherein the second variable in the transmitting antenna unit is same as the second variable in the receiving antenna unit.

14. The radar module of claim 11, wherein the first variable includes a length of the feeding line and a width of the feeding line.

15. The radar module of claim 11, wherein the second variable includes a length of the stub.

16. The radar module of claim 15, wherein the stub includes:
a first stub disposed on one side of the connection line; and
a second stub disposed on other side of the connection line opposite to the one side, and
wherein the second variable includes a length of the first stub, a length of the second stub, and a spacing between the first stub and the second stub.

17. The radar module of claim 15, wherein the radiator includes a plurality of radiators, and
wherein the feeding slot is formed in a radiator farthest from the connection line among the plurality of radiators.

18. The radar module of claim 16, wherein the connection line includes:
a transmission line connected to the transmitting antenna unit; and
a reception line connected to the receiving antenna unit, and
wherein a value of the first variable of a feeding slot of the transmitting antenna unit is same as a value of the first variable of a feeding slot of the receiving antenna unit.

19. The radar module of claim 18, wherein values of the second variables of the first and second stubs formed on the transmission line are same as values of the second variables of the first and second stubs formed on the reception line.

20. The radar module of claim 17, wherein a length of the feeding slot is adjusted within a range of 15% to 50% of a length of the farthest radiator.

21. The radar module of claim 19, wherein the communication device includes:
a plurality of transmitting terminals connected to the transmitting antenna unit; and
a plurality of receiving terminals connected to the receiving antenna,
wherein the plurality of transmitting terminals are arranged spaced apart in a first direction on the substrate,
wherein the plurality of receiving terminals are arranged spaced apart in a second direction perpendicular to the first direction on the substrate, and
wherein each of the transmitting antenna unit and the receiving antenna unit is arranged to extend in a third direction between the first direction and the second direction on the substrate.

22. The radar module of claim 21, wherein the third direction is a direction rotated by an angle of 30 to 45 degrees from the first direction to the second direction.

23. The radar module of claim 22, wherein a first length of the transmission line is different from a second length of the reception line.

24. The radar module of claim 23, wherein the first length of the transmission line is greater than the second length of the reception line.

25. The radar module of claim 24, wherein the first length is 140% or less of the second length.

26. A radar device comprising:
a radar module adapted to sense movement of an object in a vehicle; and
a control unit adapted to detect the movement of the object in the vehicle using a reception signal acquired through the radar module, and output a movement sensing signal of the object when the movement of the object is sensed,
wherein the control unit is adapted to output the movement sensing signal to at least one of a pre-registered terminal and an electronic control unit of the vehicle based on whether the sensed object is moving,
wherein the radar module includes:
a communication device disposed on the substrate;
an antenna unit disposed on the substrate; and
a connection line disposed on the substrate and connecting between the communication device and the antenna unit, and including at least one stub,
wherein the antenna unit includes a transmitting antenna unit and a receiving antenna unit,
wherein each of the transmitting antenna unit and the receiving antenna unit includes: a radiator including a feeding slot; and
a feeding line connecting between the connection line and the radiator,
wherein the stub includes a first stub arranged on one side of the connection line; and
a second stub arranged on other side of the connection line opposite to the one side,
wherein a first variable including a length of the feeding line and a width of the feeding line and a second variable including a length of the first stub, a length of the second stub, and a spacing between the first stub and the second stub are adjusted in order to adjust a direction of a beam radiated from at least one of the transmitting antenna unit and the receiving antenna unit, and
wherein at least one of the first variable and the second variable in the transmitting antenna unit is same as at least one of the first variable and the second variable in the receiving antenna unit.

27. The radar device of claim 26, wherein the first variable in the transmitting antenna unit is same as the first variable in the receiving antenna unit.

28. The radar device of claim 26, wherein the second variable in the transmitting antenna unit is same as the second variable in the receiving antenna unit.
